(19) United States
(12) Patent Application Publication
(10) Pub. No.: US 2026/0355699 A1
(43) Pub. Date: Nov. 12, 2026

(54) ION EXCHANGE MEMBRANE PRODUCTION METHOD

(71) Applicant: AGC Inc., Tokyo (JP)

(72) Inventors: Shintaro HAYABE, Tokyo (JP); Kosuke SUMIKURA, Tokyo (JP); Toshiaki SAWADA, Tokyo (JP); Ken KOMATSU, Tokyo (JP)

(73) Assignee: AGC Inc., Tokyo (JP)

(21) Appl. No.: 19/710,522

(22) Filed: Jun. 17, 2026

Related U.S. Application Data
(63) Continuation of application No. PCT/JP2024/045490, filed on Dec. 23, 2024.

(30) Foreign Application Priority Data
Dec. 26, 2023 (JP) 2023-219197

(51) Int. Cl. B01D 71/32; B01D 67/00; C25B 1/04; C25B 9/23; C25B 13/08

(52) U.S. Cl. CPC B01D 71/32; B01D 67/00931; C25B 1/04; C25B 9/23; C25B 13/08; B01D 2325/42

(57) ABSTRACT

To provide a method for producing an ion exchange membrane with which a water electrolyzer with suppressed leakage can be produced and which is excellent in chemical durability. The ion exchange membrane production method of the present disclosure comprises bringing a precursor membrane that contains a fluorinated polymer having groups convertible to ion exchange groups, and an aqueous alkaline solution that contains a water-soluble organic solvent and water, into contact with each other to hydrolyze the groups convertible to ion exchange groups thereby to obtain an ion exchange membrane that contains a fluorinated polymer having ion exchange groups; and conducing first washing treatment of washing the ion exchange membrane with water having a conductivity of 3 μS/cm or less and a temperature of 35 to 60 °C.

### TECHNICAL FIELD

The present disclosure relates to an ion exchange membrane production method.

### BACKGROUND ART

For batteries, electrolysis processes and ion separation processes, etc., an ion exchange membrane has been used. Patent Document 1 discloses a method in which a precursor membrane that contains a fluorinated polymer having —SO₂F groups is subjected to hydrolysis and conversion to acid form and then washing treatment with ultrapure water at 80 °C to obtain an ion exchange membrane that contains a fluorinated polymer having —SO₃H groups.

### PRIOR ART DOCUMENTS

### Patent Documents

Patent Document 1: JP-A-2022-044614

### DISCLOSURE OF INVENTION

### Technical Problem

In use of an ion exchange membrane as a polymer electrolyte membrane of a water electrolyzer, hydroxy radicals generated in the system during operation of the water electrolyzer may decompose the fluorinated polymer in the ion exchange membrane. Thus, an ion exchange membrane excellent in chemical durability has been required.

Further, in a case where a membrane electrode assembly produced by using an ion exchange membrane, having a gasket attached to a periphery thereof, is installed in a cell of a water electrolyzer and an electrolytic solution (for example water) is supplied to the cell, it is required that leakage from the water electrolyzer is suppressed.

The present inventors have produced a membrane electrode assembly using an ion exchange membrane as disclosed in Patent Document 1 and installed the membrane electrode assembly having a gasket attached to its periphery in a cell of a water electrolyzer, and they have found that an electrolytic solution (for example water) supplied to the cell may leak outside the water electrolyzer.

The present disclosure has been made under these circumstances, and according to an embodiment of the present invention, an object is to provide a method for producing an ion exchange membrane with which a water electrolyzer with suppressed leakage can be produced and which is excellent in chemical durability.

### Solution to Problem

The present disclosure includes the following configurations.

[1]

An ion exchange membrane production method, which comprises bringing a precursor membrane that contains a fluorinated polymer having groups convertible to ion exchange groups, and an aqueous alkaline solution that contains a water-soluble organic solvent and water, into contact with each other to hydrolyze the groups convertible to ion exchange groups thereby to obtain an ion exchange membrane that contains a fluorinated polymer having ion exchange groups, and conducting first washing treatment of washing the ion exchange membrane with water having a conductivity of 3 μS/cm or less and a temperature of 35 to 60 °C.

[2 The ion exchange membrane production method according to [1], wherein before the first washing treatment, second washing treatment of washing the ion exchange membrane with water having a temperature of 60 °C or lower is conducted.

[3 The ion exchange membrane production method according to [2], wherein the temperature of the water in the second washing treatment is lower than the temperature of the water in the first washing treatment.
[4]

The ion exchange membrane production method according to [2] or [3], wherein the water in the second washing treatment has a conductivity of 0.05 to 100 μS/cm.

[5]

The ion exchange membrane production method according to any one of [1] to [4], wherein after the first washing treatment, third washing treatment of washing the ion exchange membrane with water having a conductivity lower than that of the water in the first washing treatment and having a temperature of 60 °C or lower, is conducted.

[6]

The ion exchange membrane production method according to any one of [1] to [5], wherein the water-soluble organic solvent is at least one member selected from the group consisting of aprotic organic solvents, alcohols and amino alcohols, and the content of the water-soluble organic solvent in the aqueous alkaline solution is 5 mass % or more and 40 mass % or less to the total mass of the aqueous alkaline solution.

[7 The ion exchange membrane production method according to any one of [1] to [6], wherein after the first washing treatment, conversion to acid form is conducted.
[8 The ion exchange membrane production method according to any one of [1] to [7], wherein the fluorinated polymer having ion exchange groups has an ion exchange capacity of 0.90 to 2.05 meq/g dry resin.
[9]

The ion exchange membrane production method according to any one of [1] to [8], wherein the fluorinated polymer having ion exchange groups has units represented by the formula (2):

—[CF₂—CF(-L-(SO₃M)ₙ)]— formula (2)
in the formula (2), L is a (n+1)-valent perfluorohydrocarbon group which may contain an etheric oxygen atom, M is a hydrogen atom, an alkali metal or a quaternary ammonium cation, and n is 1 or 2.

The ion exchange membrane production method according to any one of [1] to [9], wherein the ion exchange membrane has a reinforcing material in its inside or on its surface.

The ion exchange membrane production method according to any one of [1] to [10], wherein the ion exchange membrane is used as an electrolyte membrane in a membrane electrode assembly in a water electrolyzer.

### Advantageous Effects of Invention

According to an embodiment of the present invention, it is possible to provide a method for producing an ion exchange membrane with which a water electrolyzer with suppressed leakage can be produced and which is excellent in chemical durability.

### DESCRIPTION OF EMBODIMENTS

The following definitions of terms apply throughout the present specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may be, for example, (—SO₃⁻)Ma⁺, (—SO₃⁻)₂Mb²⁺ or (—SO₃)₃Mc³⁺ (where Mat is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may be, for example, (—COO⁻) Mat, (—COO⁻) ₂Mb²⁺ or (—COO⁻)₃Mc³⁺ (where Ma⁺ is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “precursor membrane” refers to a membrane containing a polymer having groups convertible to ion exchange groups.

A “group convertible to an ion exchange group” refers to a group that can be converted to an ion exchange group by known treatments such as hydrolysis and conversion to acid form.

A “group convertible to a sulfonic acid functional group” refers to a group that can be converted to a sulfonic acid functional group by known treatments such as hydrolysis and conversion to acid form.

A “group convertible to a carboxylic acid functional group” refers to a group that can be converted to a carboxylic acid functional group by known treatments such as hydrolysis and conversion to acid form.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure. In the following, in some cases, units derived from a certain monomer will be represented by the monomer name, followed by “units”.

A numerical range expressed using “to” means a range including numerical values described before and after “to” as the lower and upper limits. In a series of numerical ranges described in the present specification, the upper limit or lower limit of a numerical range may be replaced by the upper limit or lower limit of another numerical range in the same series. The upper limit or lower limit of any numerical range described in the present specification may be replaced by any of numerical values indicated in Examples.

### [Ion Exchange Membrane Production Method]

The ion exchange membrane production method of the present disclosure (hereinafter also referred to as “present production method”) comprises bringing a precursor membrane that contains a fluorinated polymer having groups convertible to ion exchange groups (hereinafter also referred to as “precursor groups”) (hereinafter also referred to as “the fluorinated polymer (I′)”), and an aqueous alkaline solution that contains a water-soluble organic solvent and water, into contact with each other to hydrolyze the groups convertible to ion exchange groups thereby to obtain an ion exchange membrane that contains a fluorinated polymer having ion exchange groups (hereinafter also referred to as “fluorinated polymer (I)”); and conducing first washing treatment of washing the ion exchange membrane with water having a conductivity of 3 μS/cm or less and a temperature of 35 to 60 °C.

The ion exchange membrane obtained by the present production method is capable of providing a water electrolyzer with suppressed occurrence of leakage, and is also excellent in chemical resistance. The reason has not been clearly understood yet, but is estimated as follows.

After the precursor membrane is subjected to hydrolysis treatment with an aqueous alkaline solution that contains a water-soluble organic solvent and water, washing treatment may be conducted to remove the aqueous alkaline solution or the like contained in the membrane after the hydrolysis treatment in some cases. If the temperature of the water used in the washing treatment is high, the ion exchange membrane tends to have a high moisture content and have a large dimensional change and as a result, it may have wrinkles when wound into a roll and thus lowered surface smoothness. If such a wrinkled ion exchange membrane is used to produce a membrane electrode assembly and a gasket is attached to a periphery of the membrane electrode assembly, a gap may form between the gasket and the membrane electrode assembly, due to the wrinkles on the ion exchange membrane. If such a membrane electrode assembly with a gap is applied to a water electrolyzer and supply of an electrolytic solution is started, the electrolytic solution may leak through the gap.

To overcome such a problem, it is estimated that according to the present production method, by using water at a temperature of 60 °C or lower, an ion exchange membrane, with which a water electrolyzer with suppressed leakage can be produced, can be obtained.

Further, if the temperature of the water used for the washing treatment is low or the conductivity of the water used for the washing treatment is high, the water-soluble organic solvent may not sufficiently be removed by the washing treatment. If the water-soluble organic solvent contained in the aqueous alkaline solution remains in the ion exchange membrane, in application of the ion exchange membrane to a water electrolyzer, hydroxy radicals tend to form in the system during the operation, and the hydroxy radicals formed may increase the amount of the fluorinated polymer decomposed in the ion exchange membrane. To overcome such a problem, it is estimated that according to the present production method, by using water having a temperature of 35 °C or higher and a conductivity of 3 μS/cm or less, the water-soluble organic solvent contained in the membrane can sufficiently be removed, whereby an ion exchange membrane excellent in chemical durability can be obtained.

### <Precursor Membrane>

The precursor membrane used in the present production method contains the fluorinated polymer (I′).

The fluorinated polymer (I′) is not particularly limited so long as it is a polymer having fluorine atoms and having precursor groups, and is preferably a copolymer having units based on a fluorinated olefin and units based on a fluorinated monomer having a precursor group (for example, a group convertible to a sulfonic acid functional group or a group convertible to a carboxylic acid functional group), and with a view to further reducing the electrolysis voltage when the ion exchange membrane is applied to a water electrolyzer, more preferably a copolymer having units based on a fluorinated olefin and units based on a fluorinated monomer having a group convertible to a sulfonic acid functional group (hereinafter also referred to as “fluorinated monomer (S′)”) (hereinafter also referred to as “fluorinated polymer (S′)”).

Now, the fluorinated polymer (S′) will be described in detail.

The method of copolymerization for the fluorinated polymer (S′) may be a known method such as solution polymerization, suspension polymerization or emulsion polymerization.

The fluorinated olefin may be, for example, a C₂₋₃ fluoroolefin having one or more fluorine atoms in its molecule. Specific examples of the fluoroolefin include tetrafluoroethylene (hereinafter also referred to as “TFE”), chlorotrifluoroethylene, vinylidene fluoride, vinyl fluoride and hexafluoropropylene. Among them, TFE is preferred, in terms of the monomer production cost, the reactivity with other monomers and the ability to give the fluorinated polymer with excellent properties.

Single type of the fluorinated olefin may be used or two or more types may be used in combination.

The fluorinated monomer (S′) may be a compound having one or more fluorine atoms in its molecule, having an ethylenic double bond and having a group convertible to a sulfonic acid functional group.

The fluorinated monomer (S′) is preferably a compound represented by the formula (1), in view of the monomer production cost, the reactivity with other monomers and the ability to give the fluorinated polymer with excellent properties.

formula (1) CF₂═CF-L-(A) n

L is a (n+1)-valent perfluorohydrocarbon group which may contain an etheric oxygen atom.

The etheric oxygen atom may be located at a terminal end or may be located between carbon atoms of the perfluorohydrocarbon group.

The number of carbon atoms in the (n+1)-valent perfluorohydrocarbon group is preferably 1 or more, more preferably 2 or more, further preferably 3 or more, and is preferably 20 or less, more preferably 10 or less.

As L, preferred is a (n+1)-valent perfluoroaliphatic hydrocarbon group which may contain an etheric oxygen atom. More preferred is a divalent perfluoroalkylene group which may contain an etheric oxygen atom as corresponding to an embodiment of n=1, or a trivalent perfluoroaliphatic hydrocarbon group which may contain an etheric oxygen atom as corresponding to an embodiment of n=2.

The above-mentioned divalent perfluoroalkylene group may be linear or branched.

A is a group convertible to a sulfonic acid functional group. As the group convertible to a sulfonic acid functional group, preferred is a functional group that can be converted to a sulfonic acid functional group by hydrolysis. Specific examples of the group convertible to a sulfonic acid functional group include —SO₂F, —SO₂Cl and −SO₂Br.

n is 1 or 2. When n is 2, the two A may be the same or different.

The compound represented by the formula (1) is preferably a compound represented by the formula (1-1), a compound represented by the formula (1-2), a compound represented by the formula (1-3) or a compound represented by the formula (1-4).

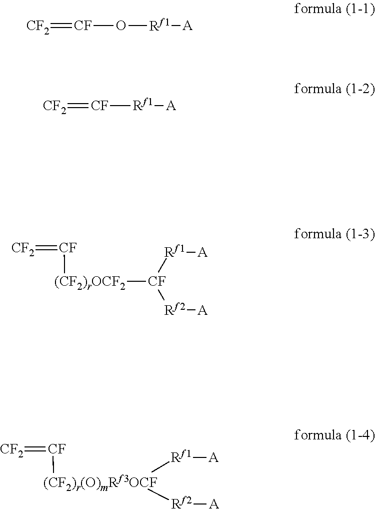

R^{f1} is a perfluoroalkylene group which may contain an oxygen atom between carbon atoms. The number of carbon atoms in the perfluoroalkylene group is preferably 1 or more, more preferably 2 or more, further preferably 3 or more, and is preferably 20 or less, more preferably 10 or less.

R^{f2} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f3} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

r is 0 or 1.

m is 0 or 1.

In the formulae, A is as defined above.

The compound represented by the formula (1-1) and the compound represented by the formula (1-2) are preferably a compound represented by the formula (1-5).

CF₂═CF—(CF₂)ₓ—(OCF₂CFY)_{y}—O—(CF₂)_{z}—SO₂F formula (1-5):

x is 0 or 1, y is an integer of 0 to 2, z is an integer of 1 to 4, and Y is F or CF₃.

Specific examples of the compound represented by the formula (1-1) include the following compounds. In the formulae, w is an integer of 1 to 8, and x is an integer of 1 to 5.

CF₂═CF—O—(CF₂)_{w}—SO₂F

CF₂═CF—O—CF₂CF(CF₃)—O—(CF₂)_{w}—SO₂F

CF₂═CF—[O—CF₂CF(CF₃)]ₓ—SO₂F

Specific examples of the compound represented by the formula (1-2) include the following compounds. In the formulae, w is an integer of 1 to 8.

CF₂═CF—(CF₂)_{w}—SO₂F

CF₂═CF—CF₂—O—(CF₂)_{w}—SO₂F

As the compound represented by the formula (1-3), a compound represented by the formula (1-3-1) is preferred.

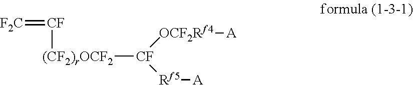

R^{f4} is a C₁₋₆ linear perfluoroalkylene group, and R^{f5} is a single bond or a C₁₋₆ linear perfluoroalkylene group which may contain an oxygen atom between carbon atoms. r and A are as defined above.

Specific examples of the compound represented by the formula (1-3-1) are as follows.

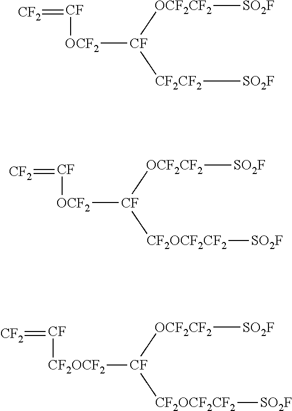

The compound represented by the formula (1-4) is preferably a compound represented by the formula (1-4-1).

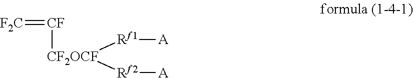

In the formula, R^{f1}, R^{f2} and A are as defined above.

Specific examples of the compound represented by the formula (1-4-1) are as follows.

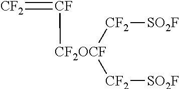

Single type of the fluorinated monomer (S′) may be used or two or more types may be used in combination.

For production of the fluorinated polymer (S′), in addition to TFE and the fluorinated monomer (S′), other monomer may be used.

Specific examples of the other monomer include CF₂═CFR^{f6} (wherein R^{f6} is a C₂₋₁₀ perfluoroalkyl group), CF₂═CF—OR^{f7} (wherein R^{f7} is a C₁₋₁₀ perfluoroalkyl group), and CF₂═CFO(CF₂)ᵥCF═CF₂ (wherein v is an integer of 1 to 3).

The content of units based on the other monomer is preferably 30 mass % or less to all units in the fluorinated polymer (I′) (preferably fluorinated polymer (S′)) with a view to maintaining the ion exchange capacity.

The ion exchange capacity of the fluorinated polymer (I′) may be adjusted by changing the content of the groups convertible to ion exchange groups in the fluorinated polymer (I′).

As an example of the precursor membrane production method, the following method may be mentioned.

First, membrane P1 that contains the fluorinated polymer (I′) is obtained using the fluorinated polymer (I′). Then, a transfer base material, the membrane P1, a reinforcing material (described later), membrane P1, and a transfer base material are stacked in this order and the obtained laminate is hot pressed, and transfer base materials disposed on both sides of the laminate are peeled to obtain a precursor membrane having membrane P1, reinforcing material, membrane P1 laminated in this order.

The precursor membrane production method has been described with reference to a case where the precursor membrane contains the reinforcing material as an example, however, the method is not limited thereto, and the precursor membrane may be produced without using the reinforcing material.

Further, in this embodiment, two membranes P1 that contain the fluorinated polymer (I′) are stacked, however, the method is not limited thereto, and one membrane P1 may be used, or three or more membranes P1 may be used. In a case where two or more membranes P1 are used, the fluorinated polymers (I′) in the two or more membranes P1 may be the same or different.

### <Ion Exchange Membrane>

The ion exchange membrane obtained by the present production method contains a fluorinated polymer (I).

The fluorinated polymer (I) is a polymer having the precursor groups in the fluorinated polymer (I′) converted to ion exchange groups.

The ion exchange groups of the fluorinated polymer (I) may be specifically sulfonic acid functional groups and carboxylic acid functional groups, and are preferably sulfonic acid functional groups, with a view to further reducing the electrolysis voltage when the ion exchange membrane is applied to a water electrolyzer.

Now, an embodiment of the fluorinated polymer having sulfonic acid functional groups (hereinafter also referred to as “fluorinated polymer(S)”) will be mainly described in detail.

The fluorinated polymer(S) preferably has units based on a fluorinated olefin and units having a sulfonic acid functional group and a fluorine atom.

The fluorinated olefin may be the above exemplified ones, and is preferably TFE.

Single type of the fluorinated olefin may be used or two or more types may be used in combination.

The units having a sulfonic acid functional group and a fluorine atom are preferably units represented by the formula (2).

[CF₂—CF(-L-(SO₃M)ₙ)]— formula (2)

In the formula (2), L and n are as defined above.

M is a hydrogen atom, an alkali metal or a quaternary ammonium cation. When n is 2, the two M may be the same or different.

The units represented by the formula (2) are preferably units represented by the formula (2-1), units represented by the formula (2-2), units represented by the formula (2-3) and units represented by the formula (2-4).

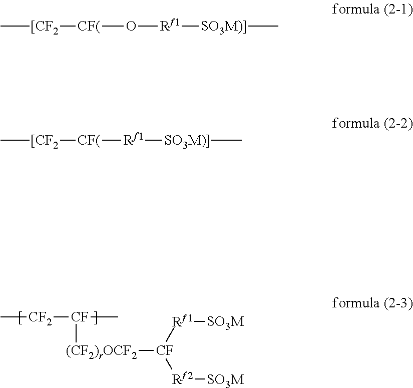

In the formulae, R^{f1}, R^{f2}, r and M are as defined above.

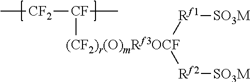

In the formula, R^{f1}, R^{f2}, R^{f3}, r, m and M are as defined above.

The units represented by the formula (2-1) and the units represented by the formula (2-2) are more preferably units represented by the formula (2-5).

[CF₂—CF(—(CF₂)ₓ—(OCF₂CFY)_{y}—O—(CF₂)_{z}—SO₃M)]— formula (2-5)

In the formula, x, y, z, Y and M are as defined above.

Specific examples of the units represented by the formula (2-1) are as follows. In the formulae, w, x and M are as defined above.

—[CF₂—CF(—O—(CF₂)_{w}—SO₃M)]-

—[CF₂—CF(—O—CF₂CF(CF₃)—O—(CF₂)_{w}—SO₃M)]-

—[CF₂—CF(—(O—CF₂CF(CF₃))x-SO₃M)]-

Specific examples of the units represented by the formula (2-2) are as follows. In the formulae, w and M are as defined above.

—[CF₂—CF(—(CF₂)_{w}—SO₃M)]-

—[CF₂—CF(—CF₂—O—(CF₂)_{w}—SO₃M)]-

The units represented by the formula (2-3) are preferably units represented by the formula (2-3-1).

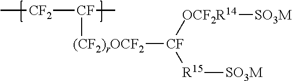

In the formula, R^{f4}, R^{f5}, r and M are as defined above.

Specific examples of the units represented by the formula (2-3-1) are as follows.

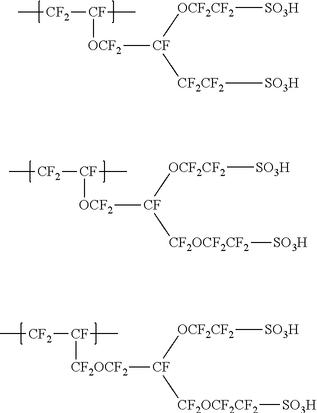

The units represented by the formula (2-4) are preferably units represented by the formula (2-4-1).

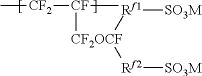

In the formula, R^{f1}, R^{f2} and M are as defined above.

Specific examples of the units represented by the formula (2-4-1) are as follows.

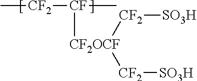

Single type of the units having a sulfonic acid functional group and a fluorine atom may be used or two or more types may be used in combination.

The fluorinated polymer (I) (preferably fluorinated polymer(S)) may have, in addition to the units based on the fluorinated olefin and the units having a sulfonic acid functional group and a fluorine atom, units based on other monomer. Specific examples of the other monomer are as described above.

The content of the units based on the other monomer is preferably 30 mass % or less to all units in the fluorinated polymer (I) with a view to maintaining the ion exchange performance.

The content of the fluorinated polymer (I) is preferably 95 to 100 mass % to the total mass of the ion exchange membrane.

The ion exchange capacity of the fluorinated polymer (I) is preferably 0.90 meq/g dry resin (hereinafter also referred to as meq/g) or more, more preferably 1.00 meq/g or more, further preferably more than 1.05 meq/g, particularly preferably 1.10 meq/g or more, in view of excellent voltage efficiency.

The ion exchange capacity of the fluorinated polymer (I) is preferably 2.05 meq/g or less, more preferably 1.50 meq/g or less, particularly preferably 1.25 meq/g or less, in view of the balance between the current efficiency and the voltage efficiency.

The ion exchange membrane may contain a reinforcing material in its inside or on its surface. That is, the ion exchange membrane may contain the fluorinated polymer (I) and a reinforcing material.

The reinforcing material may, for example, be a porous body, a fiber, a woven fabric or a non-woven fabric. The reinforcing material may be made of a polytetrafluoroethylene, a tetrafluoroethylene/hexafluoropropylene copolymer, a tetrafluoroethylene/perfluoro (alkyl vinyl ether) copolymer, a polyethylene, a polypropylene, a polyphenylene sulfide or the like.

The thickness of the ion exchange membrane is preferably 30 μm or more, more preferably 50 μm or more, further preferably 70 μm or more, particularly preferably 90 μm or more, and is preferably 300 μm or less, more preferably 200 μm or less, further preferably 150 μm or less, particularly preferably 120 μm or less. In the case where the ion exchange membrane has a multilayer structure, the thickness of the ion exchange membrane refers to the total thickness of all the layers.

The thickness of the ion exchange membrane is measured on a magnified cross-sectional image of the ion exchange membrane (e.g. at a magnification of 100) taken by an optical microscope (model “BX-51”, manufactured by Olympus Corporation). In the case where there are convex-concave parts on the surface of the ion exchange membrane, the thickness of the ion exchange membrane is an arithmetic mean of thickness measurements at total 20 points, i.e., 10 points on concave parts of the ion exchange membrane and 10 points on convex parts of the ion exchange membrane. In the case where yarns constituting the woven fabric are contained in convex parts of the ion exchange membrane, the thickness of such yarns is subtracted from the thickness of the convex parts.

### <Treatment>

Now, treatment which is conducted and treatment which may be conducted in the present production method will be described.

### (Hydrolysis)

The present production method comprises hydrolysis treatment of bringing the precursor membrane and an aqueous alkaline solution that contains a water-soluble organic solvent and water into contact with each other to hydrolyze the precursor groups of the fluorinated polymer (I′). By this treatment, an ion exchange membrane that contains the fluorinated polymer (I) will be obtained.

For example, in a case where the precursor membrane contains the above fluorinated polymer (S′), the fluorosulfonyl groups in the fluorinated polymer (S′) are converted to sulfonate by the hydrolysis treatment, whereby an ion exchange membrane that contains a fluorinated polymer having sulfonate groups is obtained.

The aqueous alkaline solution contains a water-soluble organic solvent and water and preferably further contains a basic compound.

The aqueous alkaline solution is alkaline, that is it has a pH of higher than 7.

The content of the water contained in the aqueous alkaline solution is preferably 50 mass % or more, more preferably 60 mass % or more, and is preferably 90 mass % or less, more preferably 80 mass % or less, to the total mass of the aqueous alkaline solution.

The water-soluble organic solvent refers to an organic solvent easily soluble in water. Specifically, preferred is an organic solvent with a solubility of 0.1 g or more in 1000 ml of water at a temperature of 20 °C, and an organic solvent with a solubility of 0.5 g or more is more preferred.

The water-soluble organic solvent preferably contains at least one kind selected from the group consisting of aprotic organic solvents, alcohols and amino alcohols, and more preferably contains an aprotic organic solvent.

Specific examples of the aprotic organic solvents include dimethyl sulfoxide, N,N-dimethylformamide, N,N-dimethylacetamide, N-methyl-2-pyrrolidone and N-ethyl-2-pyrrolidone. Preferred is dimethyl sulfoxide.

Specific examples of the alcohols include methanol, ethanol, isopropanol, butanol, methoxyethoxyethanol, butoxyethanol, butylcarbitol, hexyloxyethanol, octanol, 1-methoxy-2-propanol and ethylene glycol.

Specific examples of the amino alcohols include ethanolamine, N-methyl ethanolamine, N-ethyl ethanolamine, 1-amino-2-propanol, 1-amino-3-propanol, 2-aminoethoxyethanol, 2-aminothioethoxyethanol and 2-amino-2-methyl-1-propanol. Single type of the water-soluble organic solvent may be used or two or more types may be used in combination.

The content of the water-soluble organic solvent is preferably 5 mass % or more, more preferably 10 mass % or more, with a view to improving the reaction rate, and is preferably 40 mass %, more preferably 30 mass % or less, with a view to suppressing elution of the polymer.

Specific examples of the basis compound include sodium hydroxide and potassium hydroxide.

The content of the basic compound is, to the total mass of the aqueous alkaline solution, preferably 10 mass % or more, more preferably 15 mass % or more, with a view to improving the reaction rate, and is preferably 50 mass % or less, more preferably 40 mass % or less.

The temperature of the aqueous alkaline solution is preferably 60 °C or higher, more preferably 80 °C or higher, with a view to improving the reaction rate, and is preferably 120 °C or lower, more preferably 100 °C or lower, with a view to suppressing elution of the polymer.

The contact time (reaction time) of the precursor membrane and the aqueous alkaline solution is preferably 5 minutes or more, more preferably 10 minutes or more, in that the reaction will sufficiently proceed, and is preferably 2 hours or less, more preferably 1 hour or less, further preferably 30 minutes or less, with a view to suppressing elution of the polymer.

The method of contact of the precursor membrane and the aqueous alkaline solution may by a method of dipping the precursor membrane in the aqueous alkaline solution or a method of applying the aqueous alkaline solution to the surface of the precursor membrane by spaying, and is preferably dipping method.

### (First Washing Treatment)

In the present production method, first washing treatment is conducted.

The first washing treatment is a treatment to wash the ion exchange membrane with water having a conductivity of 3 μS/cm or less and a temperature of 35 to 60 °C.

The temperature of the water in the first washing treatment is 35 to 60 °C, and in view of more excellent chemical durability of the ion exchange membrane, it is preferably 40 °C or higher, more preferably 45 °C or higher, and with a view to further suppressing leakage from the water electrolyzer, it is preferably 55 °C or lower, more preferably 50 °C or lower.

The conductivity of the water in the first washing treatment is 3 μS/cm or less, and in view of more excellent chemical durability of the ion exchange membrane, preferably 2 μS/cm or less, more preferably 1 μS/cm or less, further preferably 0.8 μS/cm or less, particularly preferably 0.5 μS/cm or less.

The lower limit of the conductivity of the water in the first washing treatment is usually 0.05 μS/cm.

To adjust the conductivity to be within the above range, the water may be purified by using an ion exchange resin or the like.

The conductivity of water in this disclosure refers to electrical conductivity of water having a temperature of 25 °C, measured using an electrical conductivity meter by a method in accordance with JIS K0552-1994.

The washing time in the first washing treatment is preferably 30 seconds or more, more preferably 1 minute or more, with a view to improving the washing property.

The washing time in the first washing treatment is usually 30 minutes or less, with a view to improving the productivity.

The washing method in the first washing treatment is conducted by immersing the ion exchange membrane in the water to be used for the first washing treatment.

### (Second Washing Treatment)

In the present production method, it is preferred to conduct second washing treatment.

The second washing treatment is a treatment to wash the ion exchange membrane with water having a temperature of 60 °C or lower, before the first washing treatment.

By the second washing treatment, the water to be used in the first washing treatment is more likely to infiltrate into the ion exchange membrane and the washing effect by the first washing treatment improves, and chemical durability of the ion exchange membrane will further improve.

The water used in the second washing treatment preferably has a temperature lower than that of the water in the first washing treatment.

Specifically, the difference between the temperature of the water used in the first washing treatment and the temperature of the water used in the second washing treatment ((water temperature in the first washing treatment)-(water temperature in the second washing treatment)) is, in view of efficient washing, preferably 5 °C or more, more preferably 10 °C or more, further preferably 15 °C or more, and with a view to suppressing rapid dimensional changes of the ion exchange membrane and to suppressing wrinkles, preferably 40 °C or less, more preferably 30 °C or less.

The temperature of the water in the second washing treatment is, in view of efficient washing, preferably 10 °C or higher, more preferably 20 °C or higher, further preferably 25 °C or higher, particularly preferably 30 °C or higher, and with a view to suppressing rapid dimensional changes of the ion exchange membrane and to suppressing wrinkles, preferably 55 °C or lower, more preferably 45 °C or lower.

The temperature of the water in the second washing treatment is, in view of efficient washing, preferably 10 °C or higher, more preferably 20 °C or higher, further preferably 25 °C or higher, particularly preferably 30 °C or higher, and with a view to suppressing rapid dimensional changes of the ion exchange membrane and to suppressing wrinkles, preferably 55 °C or lower, more preferably 45 °C or lower.

The conductivity of the water in the second washing treatment is preferably 0.05 to 100 μS/cm. The conductivity of the water in the second washing treatment is, in view of more excellent chemical durability of the ion exchange membrane, more preferably 50 μS/cm or less, further preferably 10 μS/cm or less, particularly preferably 5 μS/cm or less, most preferably 3 μS/cm or less. The conductivity of the water in the second washing treatment is more preferably 0.1 μS/cm or more.

The method of adjusting the conductivity of the water used in the second washing treatment to be the above range is the same as the method described for the first washing treatment.

The washing time in the second washing treatment is, with a view to improving the washing property, preferably 10 seconds or more, more preferably 30 seconds or more.

The washing time in the second washing treatment is, with a view to improving the productivity, usually 30 minutes or less, and is preferably 10 minutes or less, more preferably 5 minutes or less.

The washing method in the second washing treatment is the same as the method described for the first washing treatment.

The amount (g/m²) of the water used in the second washing treatment per unit area of the ion exchange membrane, to the amount (g/m²) of the water used in the first washing treatment per unit area of the ion exchange membrane, is preferably 100% or less, and with a view to suppress the amount of discharge, more preferably 80% or less, further preferably 50% or less, particularly preferably 30% or less, most preferably 10% or less, and with a view to improving the washing property, it is preferably 1% or more.

### (Third Washing Treatment)

In the present production method, it is preferred to conduct third washing treatment.

The third washing treatment is a treatment to wash the ion exchange membrane with water having a conductivity lower than that of the water in the first washing treatment and having a temperature of 60 °C or lower, after the first washing treatment.

By the third washing treatment, the water-soluble organic solvent in the ion exchange membrane will further be removed, whereby the ion exchange membrane will have more improved chemical durability.

The temperature of the water in the third washing treatment is, in view of more excellent chemical durability of the ion exchange membrane, preferably 40 °C or higher, more preferably 45 °C or higher, and with a view to further suppressing leakage from the water electrolyzer, preferably 55 °C or lower, more preferably 50 °C or lower.

The conductivity of the water in the third washing treatment is lower than the conductivity of the water in the first washing treatment. Specifically, the difference between the conductivity of the water in the first washing treatment and the conductivity of the water in the third washing treatment ((conductivity of the water in the first washing treatment)−(conductivity of the water in the third washing treatment)) is preferably 0.1 μS/cm or more, more preferably 0.3 μS/cm or more, further preferably 0.5 μS/cm or more, and preferably 2.9 μS/cm or less, in that the water-soluble organic solvent in the ion exchange membrane will further be removed.

The conductivity of the water in the third washing treatment is, in view of more excellent chemical durability of the ion exchange membrane, preferably less than 3 μS/cm, more preferably 2 μS/cm or less, further preferably 1 μS/cm or less, particularly preferably 0.5 US/cm or less.

The lower limit of the conductivity of the water in the third washing treatment is usually 0.05 μS/cm.

The method of adjusting the conductivity of the water in the third washing treatment to be within the above range is the same as the method described for the first washing treatment.

The washing time in the third washing treatment is preferably 30 seconds or more, more preferably 1 minute or more, whereby the washing property will further improve.

The washing time in the third washing treatment is usually 30 minutes or less, with a view to improving the productivity.

The washing method in the third washing treatment is the same as the method described for the first washing treatment.

### (Conversion to Acid Form)

In the present production method, conversion to acid form may be conducted. The conversion to acid form is conducted preferably after the hydrolysis treatment. So long as the conversion to acid form is conducted after the hydrolysis treatment, it may be conducted before the washing treatment or may be conducted after the washing treatment, and is conducted preferably after the washing treatment. “Conducted after the washing treatment” means any of “conducted after the first washing treatment”, “conducted after the second washing treatment” and “conducted after the third washing treatment”, and is preferably “conducted after all the washing treatments” (after the third washing treatment if conducted). The conversion to acid form is a treatment to bring the ion exchange membrane after the hydrolysis treatment and an aqueous acidic solution that contains an acid component and water into contact with each other.

For example, in a case where the fluorinated polymer contained in the ion exchange membrane obtained by the hydrolysis treatment contains a sulfonate, the sulfonate is converted to a sulfonic acid group, whereby an ion exchange membrane having sulfonic acid groups is obtained.

The content of the water in the aqueous acidic solution is preferably 70 mass % or more, more preferably 75 mass % or more, and is preferably 95 mass % or less, more preferably 92 mass % or less, to the total mass of the aqueous acidic solution.

The acid component may be, for example, sulfuric acid or hydrochloric acid. The content of the acid component is, to the total mass of the aqueous acidic solution, with a view to improving the reaction rate, preferably 5 mass % or more, more preferably 8 mass % or more, and in view of handling efficiency of the aqueous acidic solution, preferably 30 mass % or less, more preferably 25 mass % or less.

The temperature of the aqueous acidic solution is, with a view to improving the reaction rate, preferably 30 °C or higher, more preferably 40 °C or higher, further preferably 50 °C or higher, and with a view to suppressing elution of the polymer, preferably 100 °C or lower, more preferably 80 °C or lower, further preferably 60 °C or lower.

The contact time (reaction time) of the ion exchange membrane after the hydrolysis treatment and the aqueous acidic solution is, in that the reaction will sufficiently proceed, preferably 10 minutes or more, more preferably 20 minutes or more, and with a view to suppressing elution of the polymer, preferably 2 hours or less, more preferably 1 hour or less.

The method of contact of the ion exchange membrane after the hydrolysis treatment and the aqueous acidic solution may be a method of immersing the precursor membrane in the aqueous acidic solution or a method of spraying the aqueous acidic solution over the surface of the precursor membrane, and is preferably the immersion method.

### <Other Treatment>

The present production method may include drying treatment. The drying treatment may be conducted several times, and is conducted preferably, for example, after the washing treatment, after the conversion to acid form and the like. Further, in a case where the first washing treatment and at least one of the second washing treatment and the third washing treatment are conducted, the drying treatment may be conducted after each washing treatment, or may be conducted only after the final washing treatment.

The drying treatment may be conducted by natural drying, heat drying, air drying or a combination thereof.

The drying temperature is, in view of drying efficiency, preferably 60 °C or higher, more preferably 80 °C or higher, further preferably 90 °C or higher, and with a view to further suppressing formation of wrinkles on the ion exchange membrane by rapid drying, preferably 150 °C or lower, more preferably 120 °C or lower, further preferably 105 °C or lower.

The drying time is, with a view to preventing the uneven drying, preferably 1 minute or more, more preferably 3 minutes or more, further preferably 5 minutes or more, and in view of drying efficiency, preferably 1 hour or less, more preferably 30 minutes or less.

The present production method may be conducted using sheet precursor membranes (that is batch process) or by roll-to-roll process.

In a case where the present production method is conducted by roll-to-roll process, a continuous precursor membrane roll is unwind, the respective treatments of the present production method are conducted, and the ion exchange membrane is wound into a roll.

### Applications

The ion exchange membrane obtained by the present production method is suitable as an electrolyte membrane contained in a membrane electrode assembly of a water electrolyzer (polymer electrolyte membrane water electrolyzer).

The membrane electrode assembly has an ion exchange membrane obtained by the present production method, a cathode catalyst layer disposed on one side of the ion exchange membrane, and an anode catalyst layer disposed on the other side of the ion exchange membrane. Each catalyst layer may have a gas diffusion layer on the side not facing the ion exchange membrane.

The membrane electrode assembly may be produced by forming the cathode catalyst layer on one side of the ion exchange membrane, forming the anode catalyst layer on the other side of the electrolyte membrane, and further stacking the gas diffusion layer if required.

The water electrolyzer comprises the above membrane electrode assembly, a water supply unit to supply water to the anode catalyst layer side, and a power supply unit for electrical connection between the anode catalyst layer side and the cathode catalyst layer side. Such a water electrolyzer, which contains the ion exchange membrane obtained by the present production method, has leakage suppressed and is excellent in chemical durability in production of hydrogen by electrolyzing water (electrolytic solution).

The ion exchange membrane obtained by the present production method may be used for applications other than the above water electrolyzers.

Specific examples of the application include various batteries such as polymer electrolyte fuel cells, direct methanol fuel cells, redox flow batteries and air batteries, and various electrolyzers for alkali water electrolysis, ozone water electrolysis, chlor-alkali electrolysis, organic electrolysis, and electrolysis of chloride, oxide, and the like. In addition, the ion exchange membrane may be used for selective cation transport at the membrane-electrode interface as a separator or a solid electrode in various types of electrochemical cells. Further, in addition to the electrochemical applications, it may be used for gas sensors, biosensors, luminous devices, optical devices and organic sensors, solubilization of carbon nanotubes, actuators, catalysts, etc.

### EXAMPLES

Now, the present invention will be described in further detail with reference to Examples. Ex. 1 to 6, 10 and 11 correspond to Examples of the present invention; and Ex. 7 to 9 correspond to Comparative Examples. It should be understood that the present invention is by no means restricted thereto.

### [Thickness of Membrane]

The thickness of the membrane was measured on a magnified cross-sectional image of the membrane (e.g. at a magnification of 100) taken by an optical microscope (model “BX-51”, manufactured by Olympus Corporation), and an arithmetic mean of thickness measurements at arbitrary 20 points was taken as the thickness of the membrane.

In the case where there were convex-concave parts on the surface of the membrane, the thickness of the membrane is an arithmetic mean of thickness measurements at total 20 points, i.e., 10 points on concave parts of the membrane and points on convex parts of the membrane. In the case where yarns constituting the woven fabric are contained in convex parts of the membrane, the thickness of such yarns is subtracted from the thickness of the convex parts.

### [Ion Exchange Capacity of Fluorinated Polymer]

The weight of a fluorinated polymer was measured, after 24 hours of incubation in a glove box purged with dry nitrogen, as the dry mass of the fluorinated polymer. Then, the fluorinated polymer was immersed in a 2 mol/L aqueous sodium chloride solution at 60 °C for 1 hour. After the fluorinated polymer was washed with ultrapure water and recovered, the solution in which the fluorinated polymer had been immersed was titrated with 0.1 mol/L aqueous sodium hydroxide solution to determine the ion exchange capacity of the fluorinated polymer.

### [Softening Point of Fluorinated Polymer]

The softening point of the fluorinated polymer was measured using a dynamic viscoelasticity measurement apparatus as follows. First, using the dynamic viscoelasticity measuring apparatus (manufactured by IT Keisoku Seigyo K.K., DVA-225), dynamic viscoelasticity measurement was conducted with a sample width of 5.0 mm with a distance between chucks of 15 mm at a measurement frequency of 1 Hz at a temperature increasing rate of 2 °C/min at a tensile mode. tan δ(loss tangent) was calculated from the ratio of the loss elasticity E″ and the elasticity modulus E′, that is E″/E′, to prepare a tan δ-temperature curve. From the prepared tan δ-temperature curve, a peak temperature within a range of −100 to 300 °C was read and taken as the softening point.

### [Conductivity of Water]

The conductivity (electrical conductivity) of water used for each washing treatment was measured at 25 °C, using an electrical conductivity meter (model “HE-300C”, manufactured by HORIBA, Ltd.) in accordance with the method of JIS K0552-1994.

### [Temperature of Water]

The temperature of water used for each washing treatment was measured, using an electrical conductivity meter (model “HE-300C”, manufactured by HORIBA, Ltd.).

### [Fluorine Release Rate]

### <Production of Membrane Electrode Assembly>

A polymer (ion exchange capacity: 1.10 meq/g dry resin) produced by copolymerization of CF₂═CF₂ and monomer (X) described later, followed by conversion to acid form through hydrolysis and acid treatment, was dispersed in a solvent of water/ethanol in a ratio of 40/60 (mass %) to obtain a dispersion with a solid content of 26.0% (hereinafter also referred to as “dispersion Y”).

The obtained dispersion Y (33.0 g) was mixed with ethanol (18.06 g) and ZEORORA H (manufactured by Zeon Corporation) (10.58 g) by a planetary centrifugal mixer (THINKY MIXER, manufactured by THINKY CORPORATION) at 2200 rpm for 5 minutes. The mixed composition (54.06 g) was mixed with ethanol (46.44 g) and water (75.75 g) and further mixed with an iridium oxide catalyst (40.0 g) (manufactured by TANAKA PRECIOUS METAL TECHNOLOGIES Co., Ltd.) containing 74.8 mass % iridium and having a specific surface area of 100 m²/g. The resulting mixed composition was processed in a planetary bead mill (rotation speed: 300 rpm) for 90 minutes to obtain an anode catalyst ink with a solid content of 22 mass %.

The anode catalyst ink was applied by an applicator to an ETFE sheet such that the amount of iridium applied was 1.0 mg/cm², dried at 80 °C for 10 minutes and heat-treated at 150 °C for 15 minutes, thereby obtaining an anode catalyst layer decal.

A supported catalyst having 46 mass % platinum supported on a carbon powder (“TEC10E50E” manufactured by TANAKA PRECIOUS METAL TECHNOLOGIES Co., Ltd.) (11 g) was mixed and milled with water (59.4 g) and ethanol (39.6 g) in an ultrasonic homogenizer to obtain a catalyst dispersion.

To the catalyst dispersion, a previously prepared mixture (29.2 g) of the dispersion Y (20.1 g), ethanol (11 g) and ZEORORA H (manufactured by Zeon Corporation) (6.3 g) was added. Further, water (3.66 g) and ethanol (7.63 g) were added to the catalyst dispersion. The obtained dispersion was mixed in a paint conditioner for 60 minutes to obtain a cathode catalyst ink with a solid content of 10.0 mass %.

The cathode catalyst ink was applied by a die coater to an ETFE sheet, dried at 80 °C and heat-treated at 150 °C for 15 minutes, thereby obtaining a cathode catalyst layer decal with a platinum content of 0.4 mg/cm².

The catalyst layer of the anode catalyst layer decal was arranged to face one side of the ion exchange membrane obtained in each Ex., and the catalyst layer of the cathode catalyst layer decal was arranged to face the other side of the ion exchange membrane. Then, the anode catalyst layer, the ion exchange membrane and the cathode catalyst layer were laminated together by hot pressing for 10 minutes at a press temperature of 150 °C and a pressure of 3 MPa. After cooling to 70 °C and releasing the pressure, the resulting laminate was taken out, and the ETFE sheets of the anode catalyst layer decal and the cathode catalyst layer decal were peeled off to obtain a membrane electrode assembly having an electrode area of 16 cm².

### Evaluation Procedure

A membrane electrode assembly was sandwiched between platinum-coated sintered titanium fiber layers (manufactured by Bekaert) having a thickness of 0.25 mm and a porosity of 60%, and then, mounted for evaluation in a single cell having an electrode area of 16 cm² and using platinum-coated titanium plates with straight channels as separators. The membrane electrode assembly was, when sandwiched, tightened so as to apply a pressure of 1.5 MPa to the electrode area.

To fully hydrate the ion exchange membrane and the ionomers in the electrodes, pure water at 60 °C and ordinary pressure with a conductivity of 1.0 μS/cm or less was supplied to both the anode catalyst layer side and the cathode catalyst layer side at a flow rate of 50 mL/min for 8 hours. Then, water electrolysis was carried out as preliminary operation for 4 hours by supplying pure water at 60 °C with a conductivity of 1.0 μS/cm or less to the anode catalyst layer side at a flow rate of 50 mL/min, with the back pressures on the anode catalyst layer side and the cathode catalyst layer side kept at ordinary pressure, while maintaining the electric current at 16 A (current density 1 A/cm²) by a high current potentio/galvanostat HCP-803 (manufactured by BioLogic). The water electrolysis operation was continued at a current density of 1 A/cm² for 1,000 hours by supplying pure water to the anode catalyst layer at a flow rate of 150 mL/min, with the back pressures on the anode side and the cathode side kept at 50 kPa.

The drainage discharged from the cathode catalyst layer side over a period from 500 hours to 1,000 hours after the preliminary operation was sampled. The content of fluoride ions in the drainage was determined by ion chromatography and averaged to calculate the average fluoride ion content per unit electrode area per unit time. The average fluoride ion content was evaluated as the fluorine release rate according to the following criteria. The grades A, B, C and D are preferred. The lower the fluorine release rate, the more the decomposition of the fluorinated polymer is suppressed, and the more excellent the chemical durability of the ion exchange membrane.

Lower than 1.5×10⁻⁶ mg/(h·cm²) A:

Higher than or equal to 1.5×10⁻⁶ mg/(h·cm²) and lower than 3.0×10⁻⁶ mg/(h·cm²) B:

Higher than or equal to 3.0×10⁻⁶ mg/(h·cm²) and lower than 10.0×10⁻⁶ mg/(h·cm²) C:

Higher than or equal to 10×10⁻⁶ mg/(h·cm²) and lower than 20.0×10⁻⁶ mg/(h·cm²) D:

Higher than or equal to 20.0×10⁻⁶ mg/(h·cm²) E:

[Evaluation of Leakage from Water Electrolyzer]

The membrane electrode assembly obtained in the same manner as the above <Production of membrane electrode assembly> in [Fluorine release rate], was heat-treated at 150 °C for 15 minutes, the periphery of the membrane electrode assembly was sandwiched between several sheets of subgaskets made of PPS (polyphenylene sulfide) and PEN (polyethylene naphthalate) stacked, and set in a water electrolysis evaluation jig EH50-25 (manufactured by Greenlight innovation) to obtain a water electrolyzer.

### Evaluation Method

To fully hydrate the polymer electrolyte membrane and the ionomers in the electrodes, pure water at 80 °C and ordinary pressure with a conductivity of 1.0 μS/cm or less was supplied to both the anode side and the cathode side at a flow rate of 50 mL/min for 12 hours. Then, the cathode side was purged with nitrogen.

After the nitrogen purge, the evaluation jig with the membrane electrode assembly was operated by a direct current power source PWR1600L manufactured by Kikusui Electronics Corporation at a current density of 2 A/cm² for 300 hours by supplying pure water at 80 °C and ordinary pressure with a conductivity of 1.0 μS/cm or less to the anode side at a flow rate of 50 mL/min and keeping the pressure of gas generated from the cathode side at atmospheric pressure. The evaluation was made based on the following standards. The grades A and B are preferred.
A: No leakage during operation for 300 hours.
B: No leakage during operation for 100 hours, and leakage observed after 100 hours.
C: Leakage observed during operation for 100 hours.

### [Production of Fluorinated Polymer (S′-1)]

CF₂═CF₂ and monomer (X) represented by the following formula (X) were copolymerized to obtain fluorinated polymer (S′-1) (ion exchange capacity: 1.25 meq/g).

CF₂═CF—O—CF₂CF(CF₃)—O—CF₂CF₂—SO₂F (X)

The ion exchange capacity described in [Production of fluorinated polymer (S′-1)] refers to the ion exchange capacity of the fluorinated polymer after hydrolysis of the fluorinated polymer (S′-1) by the after-described procedure.

### [Production of Film α1]

The fluorinated polymer (S′-1) was formed by melt-extrusion into film α1 (membrane thickness: 45 μm) formed of the fluorinated polymer (S′-1).

### [Production of Woven Fabric 1]

Using 18.6-denier yarns of PFA (tetrafluoroethylene/perfluoroether copolymer) as warp yarns and weft yarns, woven fabric A1 was produced by plain weaving such that the density of the PFA yarns was 100 yarns/inch. The fabric weight of the woven fabric A1 was 16.3 g/m².

### Ex. 1

A PET film, the film α1, the woven fabric 1, the film α1 and a PET film were stacked in this order. These stacked members were thermally press-bonded together by a roll press machine at a temperature of 200 °C and a linear pressure of 40 kg/cm, and then, the transfer base materials (PET films) on both sides were peeled off at a temperature of 50 °C to obtain a precursor membrane.

The precursor membrane was immersed in a dimethyl sulfoxide/potassium hydroxide/water=30/5.5/64.5 (mass ratio) solution for a treatment time of 30 minutes to hydrolyze and convert the groups convertible to sulfonic acid functional groups in the precursor membrane to K form sulfonic acid functional groups (hydrolysis treatment).

Then, the obtained membrane was immersed in a bath filled with water having a conductivity of 0.5 μS/cm and a temperature of 40 °C for 10 minutes (first washing treatment).

Then immersion of the membrane in 1M sulfuric acid at 40 °C for 10 minutes was repeatedly conducted twice to convert terminal groups of the sulfonic acid functional groups from K-form to H-form (conversion to acid form).

While the edge portion of the ion exchange membrane in a wet state thus obtained was fixed, the ion exchange membrane was dried at a temperature equal to or higher than the softening point (105 °C) of the fluorinated polymer (drying treatment) to obtain ion exchange membrane of Ex. 1. Drying of the ion exchange membrane in a wet state was sufficiently conducted until the content of the liquid medium in the dried ion exchange membrane became 5 mass % or less.

### Ex. 2

Ion exchange membrane of Ex. 2 was obtained in the same manner as in Ex. 1 except that after the hydrolysis treatment and before the first washing treatment, second washing treatment of immersing the membrane in a bath filled with water having a conductivity of 3.0 μS/cm and a temperature of 25 °C for 30 seconds was conducted.

### Ex. 3

Ion exchange membrane of Ex. 3 was obtained in the same manner as in Ex. 2 except that in the second washing treatment, water having a conductivity of 10.0 μS/cm and a temperature of 40 °C was used.

### Ex. 4

Ion exchange membrane of Ex. 4 was obtained in the same manner as in Ex. 1 except that after the first washing treatment and before the conversion to acid form, third washing treatment of immersing the membrane in a bath filled with water having a conductivity of 0.1 μS/cm and a temperature of 40 °C for 10 minutes was conducted.

### Ex. 5

Ion exchange membrane of Ex. 5 was obtained in the same manner as in Ex. 4 except that in the third washing treatment, water having a conductivity of 0.5 μS/cm and a temperature of 40 °C was used.

### Ex. 6

Ion exchange membrane of Ex. 6 was obtained in the same manner as in Ex. 1 except that after the hydrolysis treatment and before the first washing treatment, second washing treatment of immersing the membrane in a bath filled with water having a conductivity of 0.5 μS/cm and a temperature of 25 °C for 30 seconds was conducted, and that after the first washing treatment and before the conversion to acid form, third washing treatment of immersing the membrane in a bath filled with water having a conductivity of 0.1 μS/cm and a temperature of 40 °C for 10 minutes was conducted.

### [Ex. 7

Ion exchange membrane of Ex. 7 was obtained in the same manner as in Ex. 1 except that in the first washing treatment, water having a conductivity of 0.5 μS/cm and a temperature of 80 °C was used.

### Ex. 8

Ion exchange membrane of Ex. 8 was obtained in the same manner as in Ex. 1 except that in the first washing treatment, water having a conductivity of 0.5 μS/cm and a temperature of 25 °C was used.

### [Ex. 9

Ion exchange membrane of Ex. 9 was obtained in the same manner as in Ex. 1 except that in the first washing treatment, water having a conductivity of 10.0 μS/cm and a temperature of 40 °C was used.

### [Ex. 10

Ion exchange membrane of Ex. 10 was obtained in the same manner as in Ex. 1 except that in the first washing treatment, water having a conductivity of 0.5 μS/cm and a temperature of 60 °C was used.

### Ex. 11

Ion exchange membrane of Ex. 11 was obtained in the same manner as in Ex. 1 except that after the hydrolysis treatment and before the first washing treatment, second washing treatment of immersing the membrane in a bath filled with water having a conductivity of 100 μS/cm and a temperature of 25 °C for 30 seconds was conducted.

Using the ion exchange membrane obtained in each Ex., evaluation of leakage from the water electrolyzer and evaluation of fluorine release rate were conducted. The results are shown in Table 1. In Table 1, the temperature of the water in each washing treatment is represented as “water temperature”.

TABLE 1

| | | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|---|
| Washing | First | Water | 40 | 40 | 40 | 40 | 40 | 40 | 80 | 25 | 40 | 60 | 40 |
| treatment | washing | temperature [°C] | | | | | | | | | | | |
| | treatment | Conductivity | 0.5 | 0.5 | 0.5 | 0.5 | 0.5 | 0.5 | 0.5 | 0.5 | 10.0 | 0.5 | 0.5 |
| | | [μS/cm] | | | | | | | | | | | |
| | Second | Water | — | 25 | 40 | — | — | 25 | — | — | — | — | 25 |
| | washing | temperature [°C] | | | | | | | | | | | |
| | treatment | Conductivity | — | 3.0 | 10.0 | — | — | 0.5 | — | — | — | — | 100 |
| | | [μS/cm] | | | | | | | | | | | |
| | Third | Water | — | — | — | 40 | 40 | 40 | — | — | — | — | — |
| | washing | temperature [°C] | | | | | | | | | | | |
| | treatment | Conductivity | — | — | — | 0.1 | 0.5 | 0.1 | — | — | — | — | — |
| | | [μS/cm] | | | | | | | | | | | |

| | | | | | | | | | | | | |
|---|---|---|---|---|---|---|---|---|---|---|---|---|
| Evaluation | Leakage from water | A | A | A | A | A | A | C | A | A | B | A |
| results | electrolyzer | | | | | | | | | | | |
| | Fluorine release rate | D | B | B | B | C | A | C | E | E | C | C |

It was confirmed from Table 1 that by using water having a conductivity of 3 μS/cm or less and a temperature of 35 to 60 °C in the first washing treatment, an ion exchange membrane was obtained with which leakage from the water electrolyzer can be suppressed and which is excellent in chemical durability (Ex. 1 to 6, 10 and 11).

This application is a continuation of PCT Application No. PCT/JP2024/045490, filed on Dec. 23, 2024, which is based upon and claims the benefit of priority from Japanese Patent Application No. 2023-219197 filed on Dec. 26, 2023. The contents of those applications are incorporated herein by reference in their entireties.

What is claimed is:

1. An ion exchange membrane production method, which comprises bringing a precursor membrane that contains a fluorinated polymer having groups convertible to ion exchange groups, and an aqueous alkaline solution that contains a water-soluble organic solvent and water, into contact with each other to hydrolyze the groups convertible to ion exchange groups thereby to obtain an ion exchange membrane that contains a fluorinated polymer having ion exchange groups, and
conducting first washing treatment of washing the ion exchange membrane with water having a conductivity of 3 μS/cm or less and a temperature of 35 to 60 °C.

2. The ion exchange membrane production method according to claim 1, wherein before the first washing treatment, second washing treatment of washing the ion exchange membrane with water having a temperature of 60 °C or lower is conducted.

3. The ion exchange membrane production method according to claim 2, wherein the temperature of the water in the second washing treatment is lower than the temperature of the water in the first washing treatment.

4. The ion exchange membrane production method according to claim 2, wherein the water in the second washing treatment has a conductivity of 0.05 to 100 US/cm.

5. The ion exchange membrane production method according to claim 1, wherein after the first washing treatment, third washing treatment of washing the ion exchange membrane with water having a conductivity lower than that of the water in the first washing treatment and having a temperature of 60 °C or lower, is conducted.

6. The ion exchange membrane production method according to claim 1, wherein the water-soluble organic solvent is at least one member selected from the group consisting of aprotic organic solvents, alcohols and amino alcohols, and the content of the water-soluble organic solvent in the aqueous alkaline solution is 5 mass % or more and 40 mass % or less to the total mass of the aqueous alkaline solution.

7. The ion exchange membrane production method according to claim 1, wherein after the first washing treatment, conversion to acid form is conducted.

8. The ion exchange membrane production method according to claim 1, wherein the fluorinated polymer having ion exchange groups has an ion exchange capacity of 0.90 to 2.05 meq/g dry resin.

9. The ion exchange membrane production method according to claim 1, wherein the fluorinated polymer having ion exchange groups has units represented by the formula (2):
—[CF₂—CF(-L-(SO₃M)ₙ)]- formula (2)
in the formula (2), L is a (n+1)-valent perfluorohydrocarbon group which May contain an etheric oxygen atom, M is a hydrogen atom, an alkali metal or a quaternary ammonium cation, and n is 1 or 2.

10. The ion exchange membrane production method according to claim 1, wherein the ion exchange membrane has a reinforcing material in its inside or on its surface.

11. The ion exchange membrane production method according to claim 1, wherein the ion exchange membrane is used as an electrolyte membrane in a membrane electrode assembly in a water electrolyzer.
